(19) United States
(12) Patent Application Publication
(10) Pub. No.: US 2022/0322724 A1
(43) Pub. Date: Oct. 13, 2022

(54) NUTRITIONAL POWDER MANUFACTURING PROCESS USING MICRONIZATION, AND POWDER COMPOSITION

(71) Applicant: ABBOTT LABORATORIES, Abbott Park, IL (US)

(72) Inventors: Rockendra GUPTA, Columbus, OH (US); Jeffrey BOFF, Dublin, OH (US)

(21) Appl. No.: 17/634,611

(22) PCT Filed: Aug. 11, 2020
(86) PCT No.: PCT/US2020/045695

§ 371 Date: Feb. 11, 2022

Related U.S. Application Data
(60) Provisional application No. 62/887,016, filed on Aug. 15, 2019.

(51) Int. Cl. A23P 10/22; A23P 10/40

(52) U.S. Cl. CPC A23P 10/22; A23P 10/40

(57) ABSTRACT

Processes for preparing a powdered nutritional composition comprise dry blending protein, fat, and carbohydrate, micronizing the resultant mixture to provide 99% of particles with a size less than about 50 micrometers, and agglomerating the micronized powder to form agglomerates. Powdered nutritional compositions are produced by the processes of dry blending, micronizing, and agglomerating.

### TECHNICAL FIELD

The present invention relates to powdered nutritional compositions and processes of making powdered nutritional compositions using micronization. The processes provide powder compositions exhibiting easy reconstitution, resulting in stable emulsions.

### BACKGROUND

Powdered nutritional compositions which have historically been produced using spray drying or alternate drying technologies can be reconstituted with water to form liquid nutritional compositions. Wet oil-in-water or water-in-oil emulsions are formed and then spray or otherwise dried to produce the powdered products. However, such methods require expensive equipment, are energy intensive, and leave large economic and environmental footprints. While dry blending of various ingredients has been proposed in the past to avoid spray drying the emulsion compositions, dry blended products have typically exhibited inferior and varying solubilities, leading to unstable reconstituted liquid emulsions, sedimentation problems, and/or poor mouthfeel.

The current invention provides for powdered nutritional compositions which, upon reconstitution with water, provide stable emulsions with improved mouthfeel as compared with emulsions produced by prior dry blend technologies.

### SUMMARY

In one embodiment, the invention is generally directed to processes for preparing a powdered nutritional composition, comprising dry blending powders comprising protein, fat, and carbohydrate to form a mixture. The mixture is micronized to provide a micronized powder in which 99% of the powder particles have a size less than about 50 microns, and the micronized powder is agglomerated to form agglomerates.

The invention is also directed to powdered nutritional compositions produced by processes employing dry blending, micronizing, and agglomerating steps and to powdered nutritional compositions comprising protein, carbohydrate, and fat, and wherein 99% of the particles have a size less than about 50 micrometers (μm).

The processes of the invention are advantageous in avoiding the cost and time associated with spray drying liquid emulsion compositions. The powdered nutritional compositions of the invention are advantageous in exhibiting good emulsification properties and mouthfeel upon reconstitution with water. Additional aspects and advantages of the invention will be apparent in view of the description below.

### BRIEF DESCRIPTION OF THE DRAWINGS

The embodiments set forth in the drawings are illustrative of certain aspects of the invention and exemplary in nature and not intended to limit the invention defined by the claims, wherein:

FIG. 1 illustrates the particle size, cumulative distribution, and density distribution of a first conventional dry blended powdered nutritional composition;

FIG. 2 illustrates the particle size, cumulative distribution, and density distribution of a powdered nutritional composition similar to the composition of FIG. 1, but produced of a process of the current invention, including by dry blending and micronizing steps. More specifically, the ingredients were dry blended and passed through a mill to obtain a micronized power;

FIG. 3 illustrates the particle size, cumulative distribution, and density distribution of a second powdered nutritional composition spray dried from a wet emulsion according to a conventional process;

FIG. 4 illustrates the particle size, cumulative distribution, and density distribution of a powdered nutritional composition similar to the composition of FIG. 3, but produced by dry blending according to a conventional dry blending process.

FIG. 5 illustrates the particle size, cumulative distribution, and density distribution of a powdered nutritional composition similar to the composition of FIG. 3, but produced according to a process of the current invention, including dry blending and micronizing.

### DETAILED DESCRIPTION

Specific embodiments of the present disclosure will now be described. The invention can, however, be embodied in different forms and should not be construed as limited to the embodiments set forth herein. Rather, these embodiments are provided to illustrate more specific features of certain aspects of the invention to those skilled in the art.

Unless otherwise defined, all technical and scientific terms used herein have the same meaning as commonly understood by one of ordinary skill in the art to which embodiments of this invention belong. As used in the specification and appended claims, the singular forms “a,” “an,” and “the” are intended to include the plural forms as well, unless the context clearly indicates otherwise.

All percentages are percentages by weight of the powdered nutritional composition unless otherwise indicated.

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The terms “nutritional powder” and “powdered nutritional composition” as used herein, unless otherwise specified, refer to nutritional compositions in flowable or scoopable forms that are reconstitutable with water or another aqueous liquid prior to consumption.

The term “dry blended” as used herein, unless otherwise specified, refers to the mixing of at least one dry ingredient with another dry ingredient. In specific embodiments this refers to the addition of a dry ingredient to a dry base nutritional powder comprising multiple dry ingredients.

The current invention produces high quality, powdered nutritional compositions that reconstitute easily to provide stable emulsions. The inventive process combines dry blending and micronization so that 99% of the dry blended powder particles have a size less than about 50 μm, and in specific embodiments less than about 25 μm. The micronized particles are agglomerated to form agglomerates. Reconstitution produces a suspension that remains stable in part due to Brownian motion of the small particles, and overcomes problems which are caused by varying macromolecule solubilities.

### Dry Blending

The powdered nutritional compositions of the present disclosure may comprise protein, carbohydrate, lipid, vitamins, and minerals, and/or other ingredients suitable or conventional for use in nutritional powders.

The total amount or concentration of each ingredient in powdered nutritional compositions of the present disclosure varies considerably depending upon the selected composition and dietary or medical needs of the intended user.

### Protein

Protein can be dry blended with other ingredients described herein. Specific embodiments of the nutritional compositions described herein contain 1, 2, 3, 4, or more proteins. Non-limiting examples of proteins or sources thereof for use in the nutritional compositions include hydrolyzed, partially hydrolyzed, or non-hydrolyzed proteins or protein sources. Examples include whole egg powder, egg yolk powder, egg white powder, whey protein, whey protein concentrate, whey protein isolate, whey protein hydrolysate, milk protein concentrate, milk protein isolate, milk protein hydrolysate, nonfat dry milk, soy protein concentrate, soy protein isolate, soy protein hydrolysate, pea protein concentrate, pea protein isolate, pea protein hydrolysate, rice protein concentrate, rice protein isolate, rice protein hydrolysate, collagen protein, collagen protein hydrolysate, meat proteins such as beef protein isolate and/or chicken protein isolate, and/or a fish protein, or a combination of two or more thereof.

The protein in specific embodiments is included in the nutritional powder in an amount of from about 1% to about 25%, or from about 5% to about 20%, or from about 10% to about 18%, or from about 12% to about 15%. In some embodiments, the protein may be dry blended into the base nutritional powder in a specific amount of 5%, 10%, 15%, 20%, or even 25%. Additional specific embodiments of the nutritional powder comprise great than 50% protein.

### Fat

Fat can be dry blended with other ingredients described herein. Non-limiting examples of suitable fats or sources thereof for use in the nutritional compositions described herein include, but are not limited to, vegetable oil powder, fish oil powder, animal fat powder, dairy powder, and/or poultry fat powder, or a combination thereof.

The fat in specific embodiments is included in the nutritional powder in an amount of from about 1% to about 30%, or from about 5% to about 25%, or from about 10% to about 20%, or from about 12% to about 18%, or from about 13% to about 15%. In some embodiments, the fat may be dry blended into the base nutritional powder in a specific amount of 1%, 5%, 10%, 15%, 20%, 25%, or even 30%.

### Carbohydrate

Carbohydrate can be dry blended with other ingredients described herein. Non- limiting examples of a source of carbohydrate suitable for use in the nutritional compositions described herein include, but are not limited to, maltodextrin, hydrolyzed or modified starch, hydrolyzed or modified cornstarch, glucose polymer, corn syrup solids, rice-derived carbohydrate such as rice maltodextrin, brown rice milk powder, sucrose, glucose, fructose, lactose, sugar alcohol (e.g., maltitol, erythritol, sorbitol), isomaltulose, sucromalt, pullulan, potato starch, slowly-digested carbohydrates, dietary fibers, including but not limited to, oat fiber, corn fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal β-glucans such as oat β-glucan and/or barley β-glucan, carrageenan, psyllium, isomalto-oligosaccharides, galactooligosaccharides, monosaccharides, disaccharides, glucose polymers such as polydextrose and dextrins, fructooligosaccharides, inulin, other resistant starches, and/or an artificial sweetener, or a combination of two or more thereof.

The carbohydrate in specific embodiments is included in the nutritional powder in an amount of from about 5% to about 60%, or from about 5% to about 40%, or from about 5% to about 35%, or from about 10% to about 30%, or from about 15% to about 25%. In some embodiments, the carbohydrate may be dry blended into the base nutritional powder in a specific amount of 5%, 10%, 15%, 20%, 25%, 30%, 35%, 40%, or even 45%. Additional specific embodiments of the nutritional powder comprise great than 50% carbohydrate.

Specific embodiments comprise from about 10% protein to about 20% protein, from about 15% to about 30% fat, and from about 45% to about 55% carbohydrate. Specific embodiments comprise from about 10% protein to about 15% protein, from about 20% to about 25% fat, and from about 50% to 55% carbohydrate. A specific embodiment comprises about 15% protein, about 25% fat, and about 50% carbohydrate.

Specific embodiments comprise maltodextrin, vegetable oil, milk protein concentrate, soy protein isolate, and/or nonfat milk. In specific embodiments, the maltodextrin comprises corn maltodextrin. In specific embodiments, the vegetable oil comprises canola and/or corn oil. In specific embodiments, the composition comprises less than about 0.5% of nonfat milk.

The nutritional compositions of the present disclosure in specific embodiments further comprise ingredients that modify the physical, chemical, aesthetic, or processing characteristics of the products or serve as pharmaceutical or additional nutritional ingredients.

Non-limiting examples of such ingredients include vitamins, minerals, preservatives, emulsifying agents, buffers, prebiotics, probiotics, pharmaceutical actives, additional nutrients as described herein, colorants, flavors, thickening agents and stabilizers, lubricants, and combinations thereof.

The nutritional compositions in specific embodiments further comprise a sweetening agent, and can include at least one sugar alcohol such as maltitol, erythritol, sorbitol, xylitol, mannitol, isolmalt, and lactitol, and in specific embodiments, including at least one artificial or high potency sweetener such as acesulfame K, aspartame, sucralose, saccharin, stevia, and tagatose. These sweetening agents, especially as a combination of a sugar alcohol and an artificial sweetener, are especially useful in formulating nutritional powders which can be reconstituted to liquid beverages having a desirable flavor profile. These sweetener combinations are especially effective in masking undesirable flavors sometimes associated with the addition of vegetable proteins to a composition.

A flowing agent or anti-caking agent in specific embodiments is included in the nutritional compositions as described herein to retard clumping or caking of the powder over time and to make a powder embodiment flow easily from its container. Examples for use in a nutritional powder include tricalcium phosphate, a silicate, or a combination thereof.

A stabilizer in specific embodiments is also included in the nutritional compositions, non-limiting examples of which include gums such as xanthan gum.

The nutritional compositions in specific embodiments further comprise any of a variety of vitamins or related nutrients, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and a combination or combinations thereof.

The nutritional compositions in specific embodiments further comprise any of a variety of minerals, non-limiting examples of which include calcium, phosphorus, magnesium, iron, zinc, manganese, copper, sodium, potassium, molybdenum, chromium, chloride, and a combination or combinations thereof. Specific embodiments of the nutritional compositions also include one or more amino acids and/or branched-chain amino acids, including, but not limited to, arginine, glutamine, leucine, isoleucine and/or valine, and/or metabolites thereof such as alpha-hydroxyisocaproic acid (HICA) The nutritional compositions can also include green tea extract comprising EGCg, a catechin polyphenol. EGCg generally is the most abundant polyphenol present in green tea. The green tea extract may comprise EGCg alone, or in combination with other polyphenol compounds, including other catechins such as catechin (i.e., (+)-catechin, also known as “C”), epicatechin (“EC”), gallocatechin (“GC”), epigallocatechin (“EGC”), and epicatechin gallate (“ECg”); flavones such as apigenin, isoviloxin, sapotarin, and vicenin-2; flavonols such as kaempherol, quercetin, and myricetin; condensed flavanoids, and / or tannin glycosides.

In certain exemplary embodiments, the nutritional compositions also contain μ-hydroxy-μ-methylbutyrate (HMB). HMB is a naturally occurring short chain fatty acid metabolite of leucine that is known for use in a variety of nutritional products and supplements. Any source of HMB is suitable for use herein, including, but not limited to, the free acid, a salt, including an anhydrous salt, an ester, a lactone, or other product forms that otherwise provide a bioavailable form of HMB in the nutritional composition. Non-limiting examples of suitable salts of HMB for use herein include HMB salts, hydrated or anhydrous, of sodium, potassium, magnesium, chromium, calcium, or other non-toxic salt form. In a specific embodiment, the HMB is provided by calcium HMB monohydrate. In specific embodiments, the nutritional compositions may comprise from about 0.01 to about 10 wt % HMB. In a more specific embodiment, the nutritional compositions comprise from about from about 0.1% to about 7.0%, or more specifically, from about 0.1% to about 5.0%, HMB. In further embodiments, the nutritional compositions provide from about 1 to 3 grams, or more specifically, from about 1.5 to 3 grams, HMB per 237 ml serving.

### Micronization

Micronization provides micrometer sized particles as described herein to provide superior properties upon reconstitution. In specific embodiments, milling a dry blended mixture provides 99% of particles with a size less than about 50 μm. In specific embodiments, particles are micronized to provide 99% of particles with a size of less than 50 μm. In specific embodiments, particles are micronized to provide a majority of particles with a size of less than about 30 μm, or less than about 25 μm, or less than about 20 μm. In specific embodiments, particles are micronized to provide about 90% of the particles with a size of less than about 50 μm, or less than about 40 μm, or less than about 30 μm. In specific embodiments, particles are micronized such that greater than 50 wt% of particles in the micronized powder have a size of less than about 30 μm, or less than about 25 μm.

Particle size can be measured by laser diffraction, where particles are measured indirectly by detecting intensity distributions of laser light scattered by particles at different angles. HELOS laser diffraction, used herein, can measure particle size ranges from 0.1 μm to 8,750 μm, and can measure 2,000 particle size distributions per second.

Specific embodiments utilize milling of particles for micronization. Specific milling methods include, but are not limited to jet milling, charged milling, attrition milling, impact milling, and/or cyclone milling.

### Agglomeration

The micronized particles are agglomerated to convert the dry blended micronized powder into agglomerates with significantly enhanced emulsification properties. One method of agglomeration is fluidized bed agglomeration using an agglomerator. Powder particles are sprayed with water or lecithin, and liquid bridges form the agglomerates, with the size regulated in part by the length of time of spraying. In specific embodiments, after spraying with water or lecithin, residual moisture is evaporated, and hollow spaces are created in the resulting granulate. In specific embodiments, agglomerates are formed that are from about 50 μm to about 600 millimeters in length, width, or diameter. Due to the spaces through which water can penetrate, the agglomerates disperse within an aqueous liquid upon reconstitution of the powder composition. The agglomerates therefore eliminate or reduce the amount of lightweight micronized particles that float on the aqueous liquid surface. In specific embodiments, agglomerating produces agglomerates having an average size of greater than about 150 μm. In yet additional embodiments, agglomerating produces agglomerates having an average size from about 100 μm to about 300 μm. In additional embodiments, micronized particles are agglomerated using granulation, extrusion, or by way of rewetting agglomeration. In specific embodiments utilizing the dryblending, micronizing, and agglomerating steps, the time for formation of an emulsion can be nearly instantaneous, such as less than 1 second, or less than 5 seconds, or less than 10 seconds, or less than 15 seconds, and this time can be ½, ¼, 1/10, or 1/20 less than the time for formation of an emulsion when only dryblending is utilized.

### EXAMPLES

The following examples illustrate specific embodiments and/or features of the processes and nutritional compositions of the present disclosure. The examples are given solely for the purpose of illustration and are not to be construed as limitations of the present disclosure, as many variations thereof are possible without departing from the spirit and scope of the disclosure.

### Example 1: Micronization of Powdered Nutritional Composition

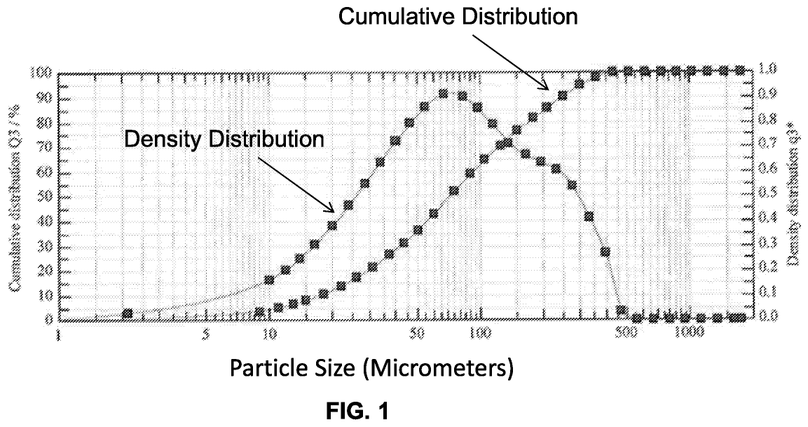

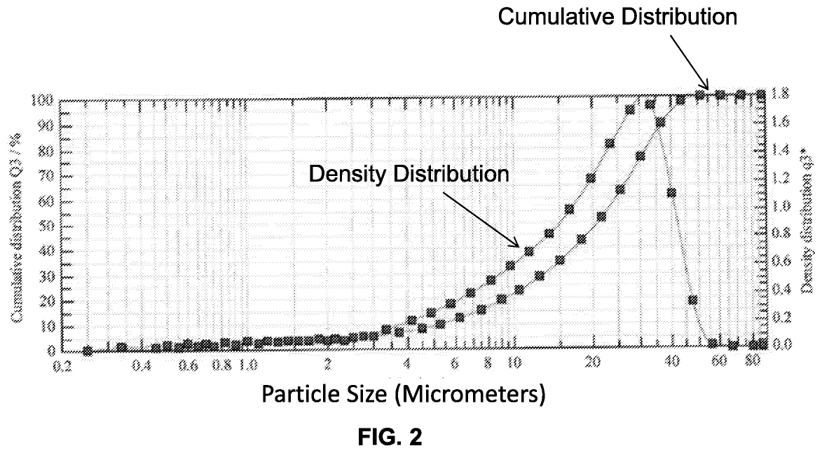

The powdered nutritional composition of this Example comprises maltodextrin and multiple protein sources, among other ingredients, as shown in Table 1, below. This is the powdered nutritional composition used to generate the particle size data of FIG. 1, illustrating a conventional dry blended composition, and FIG. 2 which illustrates the composition after dry blending and micronization.

TABLE 1

| | Amount (g) |
|---|---|
| Ingredient | per Kg |
| High Oleic Sunflower Oil | 321.2 |
| Powder | |
| Maltodextrin | 236.2 |
| Sodium Caseinate | 113.4 |
| Soy Protein Isolate | 81.5 |
| Fructooligosaccharide | 74.1 |
| Sucrose | 70.9 |
| Whey protein concentrate | 39.9 |
| Calcium HMB | 15.1 |
| Potassium Citrate | 14.7 |
| Tricalcium phosphate | 6.7 |
| Magnesium Sulfate | 5.6 |
| Potassium Chloride | 4.4 |
| Magnesium Chloride | 4.3 |
| Sodium Citrate | 3.1 |
| Potassium Phosphate Dibasic | 2.6 |
| Sodium Chloride | 1.7 |
| Calcium Carbonate | 1.1 |
| Ascorbic Acid | 0.94 |
| Vitamins and Minerals | qs. |

More specifically, FIG. 1 illustrates the particle size measured by HELOS laser diffraction. The x-axis illustrates particle size of the nutritional composition in powder form. All of the particles (X₁₀₀, referring to 100% of the particles X) are 510 μm or smaller. Other reference points of FIG. 1 include: X₁₀ =17.51 μm, X₁₆ =24.76 μm, X₅₀ =72.25 μm, X₈₄ =198.93 μm, X₉₀ =248.65 μm and X₉₉ =404.87 μm. More specifically, the particle measurements are illustrated in FIG. 1 as a cumulative distribution. The cumulative distribution is generated by plotting points determined by showing the fraction of particles in increasing Q3 intervals along the x-axis as a percentage of the total quantity of the particles. The left side of the y-axis shows the scale for this percentage. For example, 72.25 μm on the x-axis correlates to a reading of 50% on the y-axis, indicating that 50% of all particles are 72.25 μm or smaller. Also shown at the right side of the y-axis is the scale for density distribution, which is generated by taking the log of the derivative of the cumulative distribution points, to generate points (q3). The density distribution illustrates the frequency of particle sizes. The mode is the peak of the density distribution. The mode represents the particle size most commonly found in the density distribution.

In comparison, FIG. 2 illustrates the particle size, cumulative distribution, and density distribution of a powdered nutritional composition similar to that of FIG. 1, but produced according to a process of the current invention, including dry blending and micronizing. FIG. 2 illustrates the HELOS laser diffraction particle size analysis. All of the particles, X₁₀₀, are 61.50 μm or smaller. Also shown in FIG. 2, X₁₀ =5.39 μm, X₁₆ =7.82 μm, X₅₀ =20.87 μm, X₈₄ =34.22 μm, X₉₀ =37.22, and X₉₉ =48.43 μm.

Example 2: Micronization of Powdered Nutritional Composition

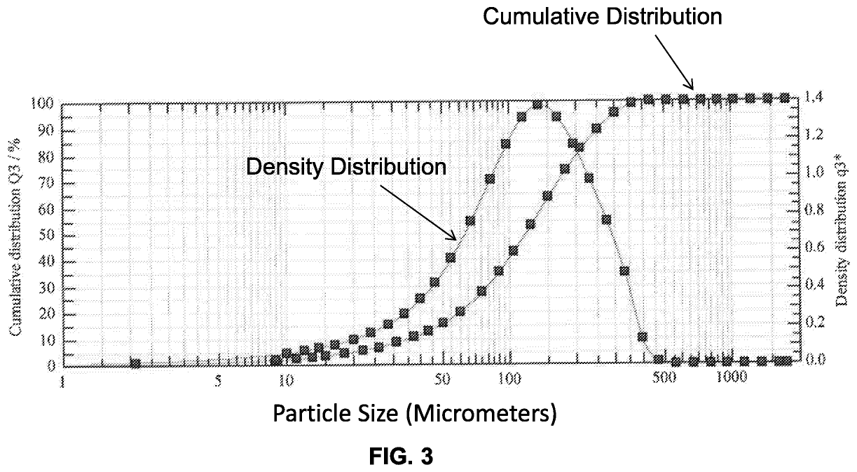

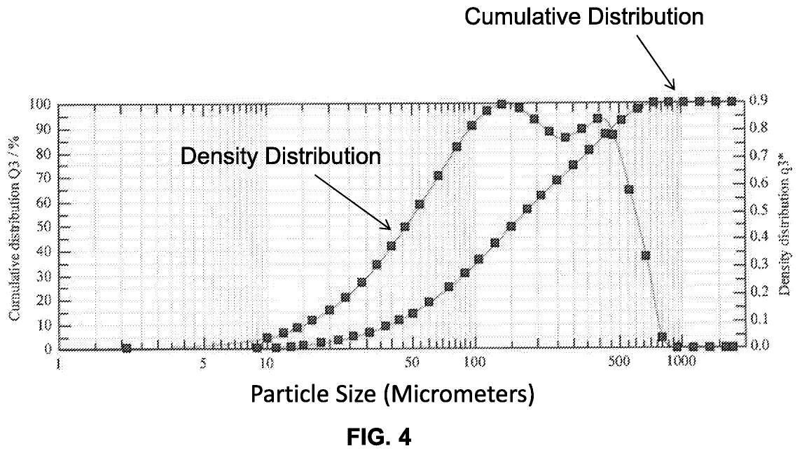

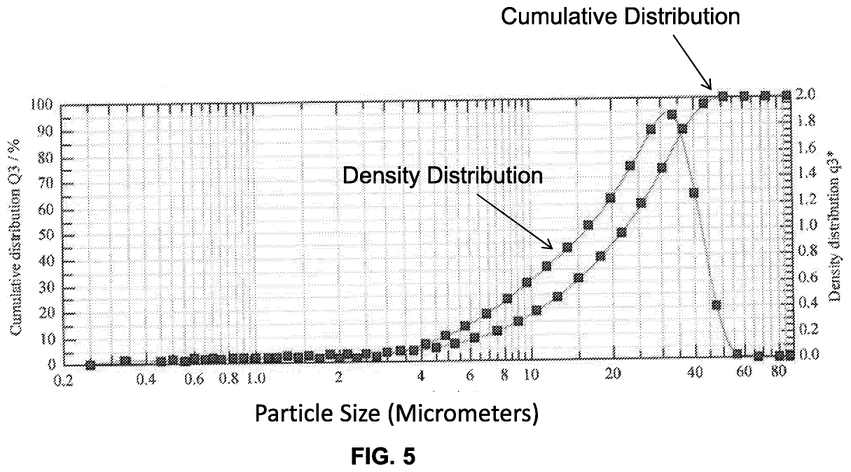

The powdered nutritional composition of this Example comprises maltodextrin, and as a source of protein contains non-fat dry milk, along with other ingredients shown in Table 2, below. This is the powdered nutritional composition used to generate the particle size data of FIGS. 3, 4, and 5. More specifically, FIGS. 3, 4, and 5 illustrate the particle size, cumulative distribution, and density distribution of a second powdered nutritional composition spray dried from a wet emulsion according to a conventional process (FIG. 3), dry blended according to a conventional process (FIG. 4), and produced by the dry blending and micronizing steps of the current invention (FIG. 5). FIGS.1-5 provide data on particle size, but do not show agglomeration.

TABLE 2

| | Amount | |
|---|---|---|
| Ingredient | per Kg | Unit |
| Non-Fat Dry Milk | 443.7 | g |
| Oil Powder | 357.8 | g |
| Sucrose | 156.9 | g |
| Fructooligosaccharide | 19.7 | g |
| Vanilla Flavor | 9.4 | g |
| Potassium Citrate | 3.4 | g |
| Magnesium Carbonate | 2.1 | g |
| Sodium Citrate | 1.9 | g |
| Ascorbic Acid | 1.2 | g |
| Vitamins Mix | 1.0 | g |
| Mineral Mix | 0.8 | g |
| Other Vitamins/Minerals | q s. | |
| and Functional Ingredients | | |

In this example, a HELOS laser diffraction particle size analysis was performed. FIG.3 shows all of the particles, X₁₀₀, are 510 μm or smaller. Also shown in FIG. 3, X₁₀ =36.26 μm, X₁₆ =51.52 μm, X₅₀ =119.75 μm, X₈₄ =222.47 μm, X₉₀ =257.38 μm, and X₉₉ =364.90 μm. FIG. 4 shows all of the particles, X₁₀₀, are 870 μm or smaller. Also shown in FIG. 4, X₁₀ =39.82 μm, X₁₆ =54.29 μm, X₅₀ =152.32 μm, X₈₄ =398.65 μm, X₉₀ =473.04 μm, and X₉₉ =695.71 μm.

FIG.5 shows all of the particles, X₁₀₀, are 61.5 μm or smaller. Also shown in FIG. 5, X₁₀ =7.05 μm, X₁₆ =9.51 μm, X₅₀ =22.12 μm, X₈₄ =35.09 μm, X₉₀ =38.38 μm, and X₉₉ =49.01 μm.

Examples described herein are exemplary only and are not limiting to the invention defined by the claims.

1. A process for preparing a powdered nutritional composition, comprising:
dry blending powders comprising protein, fat, and carbohydrate to form a mixture;
micronizing the mixture to provide a micronized powder in which 99% of the powder particles have a size less than about 50 micrometers; and
agglomerating the micronized powder to form agglomerates.

2. The process of claim 1, wherein greater than 50 wt% of the particles in the micronized powder have a size of less than about 30 micrometers.

3. The process of claim 1, wherein greater than 50 wt% of the particles in the micronized powder have a size of less than about 25 micrometers.

4. The process of claim 1, wherein greater than 90 wt% of the particles in the micronized powder have a size of less than about 40 micrometers.

5. The process of claim 1, wherein the step of micronizing comprises milling.

6. The process of claim 1, wherein the step of agglomerating produces agglomerates having an average size of greater than about 100 micrometers.

7. The process of claim 1, wherein the step of agglomerating produces agglomerates having an average size from about 50 μm to about 600 micrometers.

8. The process of claim 1, wherein the step of agglomerating comprises spraying the particles with water or lecithin in a fluidized bed agglomerator.

9. The process of claim 1, wherein the step of agglomerating comprises spraying the particles with water in a fluidized bed agglomerator.

10. The process of claim 1, wherein the protein comprises whole egg powder, egg yolk powder, egg white powder, whey protein, whey protein concentrate, whey protein isolate, whey protein hydrolysate, milk protein concentrate, milk protein isolate, milk protein hydrolysate, nonfat dry milk, soy protein concentrate, soy protein isolate, soy protein hydrolysate, pea protein concentrate, pea protein isolate, pea protein hydrolysate, rice protein concentrate, rice protein isolate, rice protein hydrolysate, collagen protein, collagen protein hydrolysate, beef protein isolate, chicken protein isolate, and/or fish protein.

11. The process of claim 1, wherein the carbohydrate comprises maltodextrin, hydrolyzed or modified starch or cornstarch, glucose polymers, corn syrup solids, rice-derived carbohydrates, pea-derived carbohydrates, potato-derived carbohydrates, sucrose, glucose, fructose, lactose, maltitol, erythritol, sorbitol, sucralose, acesulfame potassium, and/or stevia.

12. The process of claim 1, wherein the fat comprises vegetable oil powder, fish oil powder, animal fat powder, dairy powder, and/or poultry fat powder.

13. A powdered nutritional composition produced by the process of claim 1, comprising agglomerates of particles, wherein 99% of the particles have a size less than about 50 micrometers.

14. The powdered nutritional composition of claim 13, wherein greater than 50 wt% of the particles in the micronized powder have a size of less than about 30 micrometers.

15. The powdered nutritional composition of claim 13, wherein greater than 50 wt% of the particles in the micronized powder have a size of less than about 25 micrometers.

16. The powdered nutritional composition of claim 13, wherein greater than 90 wt% of the particles in the micronized powder have a size of less than about 40 micrometers.

17. A powdered nutritional composition, comprising agglomerates of particles comprising protein, fat, and carbohydrate, wherein 99% of the particles have a size less than 50 micrometers.

18. The powdered nutritional composition of claim 17, wherein greater than 50 wt% of the particles in the micronized powder have a size of less than about 30 micrometers.

19. The powdered nutritional composition of claim 17, wherein greater than 50 wt% of the particles in the micronized powder have a size of less than about 25 micrometers.

20. The powdered nutritional composition of claim 17, wherein greater than 90 wt% of the particles in the micronized powder have a size of less than about 40 micrometers.
